(19) United States
(12) Patent Application Publication
(10) Pub. No.: US 2007/0220377 A1
(43) Pub. Date: Sep. 20, 2007

(54) Interleaving apparatus and method in communication system

(75) Inventors: Jeung-Uk Park, Seongnam-si (KR); Chong-Don Kim, Seongnam-si (KR); Sun-Young Choi, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/704,168

(22) Filed: Feb. 8, 2007

(30) Foreign Application Priority Data
Feb. 9, 2006 (KR) 2006-0012440

(51) Int. Cl. G06F 11/00

(52) U.S. Cl. 714/701

(57) ABSTRACT

Provided are an interleaving apparatus and method in a communication system. The interleaving apparatus includes a determiner for determining whether a next index k to be generated is an index to be discarded, and if the next index k is the index to be discarded, generating a skip signal; an index generator responding to a clock to increase the next index k by “1” and output the increased index k, and if the skip signal is detected, increasing the index k by “2” and outputting the increased index k; and an address generator performing a predetermined operation using the index k generated by the index generator to generate an address required for interleaving. Thus, a number of clocks required for interleaving and/or deinterleaving can be reduced.

### PRIORITY

This application claims priority under 35 U.S.C. § 119 to an application filed in the Korean Intellectual Property Office on Feb. 9, 2006 and assigned Serial No. 2006-12440, the contents of which are incorporated herein by reference.

### BACKGROUND OF THE INVENTION

1. Field of the Invention

The present invention relates generally to an interleaving apparatus and method in a communication system, and in particular, to an apparatus and a method for generating an address necessary for an interleaving operation.

2. Description of the Related Art

In general, a wired and/or wireless digital communication system uses error correction codes (ECCs) to correct errors on a transmission line. A coder (hereinafter referred to as a turbo coder) using a turbo code as one of the ECCs is a system which generates parity bits using two parallel concatenated codes. The turbo coder also includes two (first and second) component encoders and an internal interleaver. Here, the two component encoders use recursive systematic convolutional (RSC) codes, and the internal interleaver interleaves an input bit stream and provides the interleaved bit stream to the second component encoder.

The turbo coder receives and processes an information bit at every clock, while a coder (hereinafter referred to as a convolutional turbo coder) using a convolutional turbo code (CTC) receives and processes two information bits at every clock. The CTC is adopted in a channel coder of a broadband wireless communication system and has a similar format to the turbo code.

FIG. 1 is a block diagram of a sub-packet generating apparatus in a general broadband wireless communication system. Referring to FIG. 1, a CTC coder 100 codes an input information bit stream using a CTC to generate coded bits. Here, a coding rate of the CTC coder 100 is assumed to be ⅓. In other words, if two information bits are input, six bits are generated.

A channel interleaver 102 interleaves and outputs the coded bits output from the CTC coder 100 to disperse a burst error caused by fading occurring in a wireless channel. Here, the channel interleaver 102 interleaves and outputs the coded bits output from the CTC coder 100 in units of sub-blocks.

A puncturer 104 punctures the bits interleaved by the channel interleaver 102 to generate a sub-packet to be transmitted. In other words, the puncturer 104 selects bits to be transmitted among the bits interleaved by the channel interleaver 102 to generate the sub-packet.

FIG. 2 is a detailed block diagram of the channel interleaver 102 of FIG. 1. As shown in FIG. 2, first and second information blocks generated by the CTC coder 100 are represented as sub-blocks A and B, respectively. Also, first and second parity blocks generated by a first convolutional coder of the CTC coder 100 are represented as sub-blocks Y1 and Y2, respectively. First and second parity blocks generated by a second convolutional coder of the CTC coder 100 are represented as sub-blocks W1 and W2, respectively. Interleaving rules will now be described in each step.

Splitting of Bits

First, second, third, fourth, fifth, and sixth bits, which are generated by the C coder 100 at every clock, are stored in the sub-blocks A (200), B (202), Y1 (204), Y2 (206), W1 (208), and W2 (210), respectively.

Interleaving of Sub-blocks

The six sub-blocks 200 through 210 are separately interleaved through first through fifth steps.

1. Parameters m and J of sub-block interleavers are determined using Table 1 below. N is a size of the interleaver, and EP refers to an encoding packet.

TABLE 1

| | | | Sub-block Interleaver | |
|---|---|---|---|---|
| | Block | | Parameters | |
| Index | Size (N_EP) | N | m | J |
| 0 | 48 | 24 | 3 | 3 |
| 1 | 72 | 36 | 4 | 3 |
| 2 | 96 | 48 | 4 | 3 |
| 3 | 144 | 72 | 5 | 3 |
| 4 | 192 | 96 | 5 | 3 |
| 5 | 216 | 108 | 5 | 4 |
| 6 | 240 | 120 | 6 | 2 |
| 7 | 288 | 144 | 6 | 3 |
| 8 | 360 | 180 | 6 | 3 |
| 9 | 384 | 192 | 6 | 3 |
| 10 | 432 | 216 | 6 | 4 |
| 11 | 480 | 240 | 7 | 2 |
| 12 | 960 | 480 | 8 | 2 |
| 13 | 1920 | 960 | 9 | 2 |
| 14 | 2880 | 1440 | 9 | 3 |
| 15 | 3840 | 1920 | 10 | 2 |
| 16 | 4800 | 2400 | 10 | 3 |

2. Indexes i and k are initialized to “0”.

3. A read address is generated using Equation (1):
Tₖ=2^{m}(k mod J)+BROₘ(└k/J┘) (1)
wherein m and J denote parameters obtained from Table 1 above, BRO(H) denotes a function for bit reverse ordering of H, mod and / denote a modulo operation and a divider operation for calculating a remainder and a share, respectively.

4. If a generated read address Tₖ is smaller than an interleaver size N, Aᵢ=Tₖ, and the indexes i and k are each increased by “1”. If the generated read address Tₖ is not smaller than the interleaver size N, the generated read address Tₖ is discarded, and only the index k is increased.

5. Third and fourth steps are repeated until all of read addresses are obtained.

Grouping of Bits

The interleaved sub-blocks A and B are intactly output, but each of the interleaved sub-blocks Y1 and Y2 is multiplexed and output in the format of “Y1, Y2, Y1, Y2, . . . , and Y1, Y2” as shown in FIG. 2. Each of the interleaved sub-blocks W1 and W2 is also multiplexed and output in the format of “W1, W2, W1, W2, . . . , and W1, W2”, also shown in FIG. 2.

The above-described conventional interleaving method has the following problems.

Unnecessary clocks are used to calculate read addresses to be discarded. If a block size N_EP is “4800”, a size of a block interleaver is “3072(2¹⁰*3)”, and a number of substantial information bits in the block interleaver is “2400”. Thus, a number of read addresses to be discarded is “672(3072−2400)”. Also, if whole interleaving is performed using a serial operation, a number of substantially necessary clocks is “18432(3072*6)”, and a number of clocks used for calculating the read addresses to be discarded is “4032(672*6)” among the substantially necessary clocks. In other words, 20% of the clocks are unnecessarily used. In addition, the use of the unnecessary clocks is a factor which increases a time required for interleaving.

### SUMMARY OF THE INVENTION

An aspect of the present invention is to substantially solve at least the above problems and/or disadvantages and to provide at least the advantages below. Accordingly, an aspect of the present invention is to provide an apparatus and a method for reducing a time required for interleaving and/or deinterleaving in a communication system.

Another aspect of the present invention is to provide an apparatus and a method for disallowing addresses to be discarded to be generated among a series of addresses generated for interleaving and/or deinterleaving in a communication system.

A further aspect of the present invention is to provide an apparatus and a method for reducing a number of clocks required for interleaving and/or deinterleaving in a communication system.

According to one aspect of the present invention, there is provided an interleaving apparatus including a determiner for determining whether a next index k to be generated is an index to be discarded, and if the next index k is the index to be discarded, generating a skip signal; an index generator responding to a clock to increase the next index k by “1” and output the increased index k, and if the skip signal is detected, increasing the index k by “2” and outputting the increased index k; and an address generator performing a predetermined operation using the index k generated by the index generator to generate an address required for interleaving.

According to another aspect of the present invention, there is provided a transmitting apparatus in a communication system, including a channel coder encoding and outputting transmitted data; and a channel interleaver interleaving and outputting the transmitted data encoded by the channel coder, wherein the channel interleaver includes a determiner for determining whether a next index k to be generated is an index to be discarded, and if the next index k is the index to be discarded, generating a skip signal; an index generator responding to a clock to increase the next index k by “1” and output the increased index k, and if the skip signal is detected, increasing the index k by “2” and outputting the increased index k; and an address generator performing a predetermined operation using the index k generated by the index generator to generate an address required for interleaving.

According to a further aspect of the present invention, there is provided an interleaving method including sequentially storing input data in a memory; responding to a clock to increase an index k by “1”, and if a next index k to be generated is an index to be discarded, increasing the index k by “2”; performing a predetermined operation using the index k to generate an address; and reading data from the memory according to the address.

According still another aspect of the present invention, there is provided a transmitting method in a communication system, including encoding transmitted data; sequentially storing the encoded data in a memory; responding to a clock to increase an index k by “1”, and if a next index k to be generated is an index to be discarded, increasing the index k by “2”; performing a predetermined operation using the index k to generate an address; and interleaving and outputting the stored data according to the generated address.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a sub-packet generating apparatus in a general broadband wireless communication system;

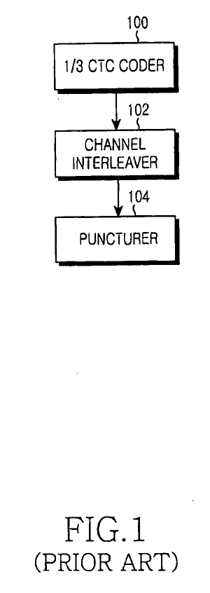

FIG. 2 is a detailed block diagram of a channel interleaver of FIG. 1;

FIG. 3 is a block diagram of an interleaver according to the present invention; and

FIG. 4 is a flowchart of a method of generating a read address in an interleaver according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail. Also, terms to be described later are defined in consideration of functions in the present invention and thus may vary with intentions of users or operators, usage, etc. Therefore, the definition of the terms must be based on the overall contents of the present specification.

The present invention provides a method for disallowing addresses to be discarded to be generated among a series of addresses generated for interleaving and/or deinterleaving in a communication system. Hereinafter, a channel interleaver used in an Orthogonal Frequency Division Multiplexing (OFDM)-based broadband wireless communication system will be exemplarily described. However, an interleaving method according to the present invention may be equally applied to interleavers used in various fields such as a channel interleaver used in a Code Division Multiple Access (CDMA)-based communication system, an internal interleaver of a turbo coder, etc.

Prior to the description of the present invention, the parameters m and J of Table 1 above will be newly defined.

If a value of the parameter J, which is inserted as a divisor into Equation 1 above, is not a multiple of “2”, the parameter J is a considerable burden on a size and a timing of a logic. For example, if the parameter J is “4”, a dividend is simply bit-shifted to the right two times. If the parameter J is “2”, the dividend is bit-shifted to the right once. Thus, an operation can be simply performed. If the parameter J is “3”, a bit shift and a division logic must be additionally used.

Accordingly, parameters m and J of an interleaver applied to Evolution Data and Voice (1×EV-DV) are newly defined in Korean Patent Publication No. 10-2005-94304 which is assigned to the assignee of the present application. In view of this, Table 1 above may be rearranged to form Table 2 below.

TABLE 2

| | Block | | Sub-block Interleaver Parameters | |
|---|---|---|---|---|
| Index | Size (N_EP) | N | m | J |
| 0 | 48 | 24 | 4 | 2 |
| 1 | 72 | 36 | 5 | 2 |
| 2 | 96 | 48 | 5 | 2 |
| 3 | 144 | 72 | 6 | 2 |
| 4 | 192 | 96 | 6 | 2 |
| 5 | 216 | 108 | 5 | 4 |
| 6 | 240 | 120 | 6 | 2 |
| 7 | 288 | 144 | 7 | 4 |
| 8 | 360 | 180 | 7 | 4 |
| 9 | 384 | 192 | 7 | 4 |
| 10 | 432 | 216 | 6 | 4 |
| 11 | 480 | 240 | 7 | 2 |
| 12 | 960 | 480 | 8 | 2 |
| 13 | 1920 | 960 | 9 | 2 |
| 14 | 2880 | 1440 | 10 | 4 |
| 15 | 3840 | 1920 | 10 | 2 |
| 16 | 4800 | 2400 | 11 | 4 |

Thus, if the value of the parameter J is adjusted to a multiple of “2”, Equation (1) above must be revised into Equation (2) below. The detailed description of Equation (2) below is disclosed in Korean Patent Publication No. 10-2005-94304 and thus will be omitted herein.
Tₖ=2^{m}(└k/J┘mod J)+BROₘ((└k/4*J)+(k mod J)) (2)
wherein m and J denote parameters obtained from Table 2 above, BRO(H) denotes a function for bit reverse ordering of H which is a binary bit stream, and mod and / denote a modulo operation and a divider operation for obtaining a remainder and a share, respectively.

An embodiment of the present invention will be described with reference to Table 2 above.

If an index k to be discarded or a read address is recognized in advance, the index k may not be generated from the start. For example, if a block size N_EP is “48”, a total number of indexes k to be discarded is “8”, i.e., “0×3(=3), 0×7(=7), 0×B(=12), 0×F(=15), 0×13(=18), 0×17(=23), 0×1B(=28), and 0×1F(=31)”. If four lower order bits are “0×3, 0×7, 0×B, and 0×F”, the eight indexes k are discarded. Rules for indexes to be discarded according to the above-described method are looked up. If the index k to be discarded is skipped, an operation may be performed without losing clocks.

Here, 0× is an identification representing hexadecimal numeric. Hexadecimal numeric uses nine numbers(0˜9) and 6 alphabets{A(10), B(11), C(12), D(13), E(14), F(15)}.

Rules for indexes k immediately before the index k to be discarded are arranged as in Table 3 below

TABLE 3

| | First Condition: | |
|---|---|---|
| Index | K_idx[3:0] | Second Condition |
| 0 | 0x2, 0x6, 0xA, 0xE | |
| 1 | 0x2, 0x5, 0x9, 0xD | |
| 2 | 0x2, 0x6, 0xA, 0xE | |
| 3 | 0x2, 0x5, 0x9, 0xD | |
| 4 | 0x2, 0x6, 0xA, 0xE | |
| 5 | 0x6, 0xE | |
| | 0xA | If K_idx[4] is “1” |
| 6 | 0xE | |
| 7 | 0x2, 0x5, 0x9, 0xD | |
| 8 | 0x2, 0x6, 0xA, 0xE | |
| | 0xD | If K_idx[7:4] is not “0x0, 0x4, 0x8, and |
| | 0xC” | |
| 9 | 0x2, 0x6, 0xA, 0xE | |
| 10 | 0x6, 0xE | |
| | 0xA | If K_idx[4] is “1” |
| 11 | 0xE | |
| 12 | 0xE | |
| 13 | 0xE | |
| 14 | 0x2, 0x6, 0xA, 0xE | |
| | 0xE | If K_idx[7:4] is not “0x0, 0x4, 0x8, |
| | and 0xC” | |
| 15 | 0xE | |
| 16 | 0x2, 0xA, 0xD, 0x5 | |
| | 0x9 | If K_idx[4] is “1”, if K_idx[6:4] is “6” |

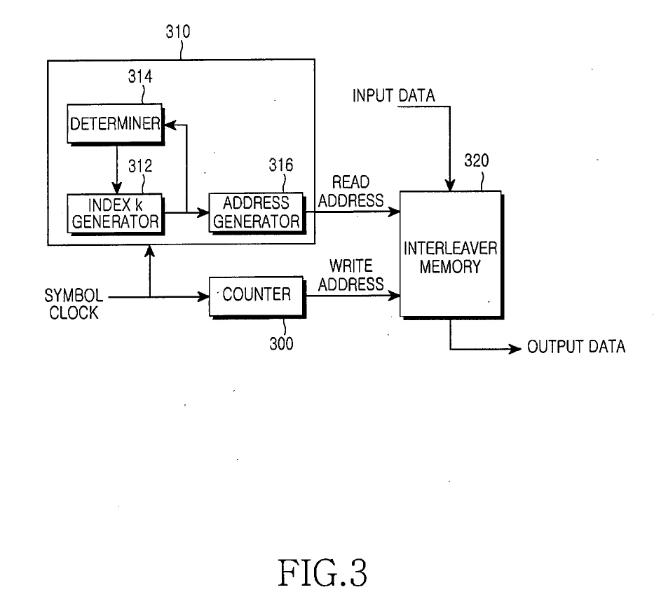

FIG. 3 is a block diagram of an interleaver according to the present invention. Referring to FIG. 3, the interleaver according to the present invention includes a counter 300, a read address generator 310, and an interleaver memory 320. The read address generator 310 includes an index k generator 312, a determiner 314, and an address generator 316.

In a write mode, the counter 300 responds to an input symbol clock to perform counting and outputs the counted value as a write address to the interleaver memory 320. The interleaver memory 320 sequentially stores input data according to the write address output from the counter 300 in the write mode.

In a read mode, the read address generator 310 responds to the input symbol clock to generate a read address for permutating the data stored in the interleaver memory 320. The interleaver memory 320 randomly outputs the stored data according to the read address output from the read address generator 310 in the read mode. The interleaver memory 320 may sequentially store data in a write mode and randomly output the stored data in a read mode as described. Alternatively, the interleaver memory 320 may randomly store data in the write mode and sequentially output the stored data in the read mode.

The read address generator 310, a core element of the present invention, will now be described in more detail.

The index k generator 312 includes a counter and basically responds to the input symbol clock provided from an external source to count and output an index k by “1”. However, if the index k generator 312 receives a skip signal from the determiner 314, the index k generator 312 counts and outputs the index k by “2”.

The determiner 314 includes a lookup table such as Table 3 above, determines whether the index k generated by the index k generator 312 satisfies specific rules (Table 3), and if the index k satisfies the specific rules, outputs the skip signal to the index k generator 312. In other words, the determiner 314 determines whether an index k to be generated is an index k to be discarded, and if the index k to be generated is the index k to be discarded, outputs a signal for skipping a corresponding index to the index k generator 312.

The address generator 316 includes a lookup table such as Table 2 above and performs a predetermined operation using the index k generated by the index k generator 312 and parameters m and J obtained from the lookup table to generate the read address. Here, the predetermined operation may be equal to Equation (2) above.

As described above, an interleaving apparatus according to the present invention disallows a value corresponding to a corresponding address to be counted beforehand based on the fact that an address to be discarded among addresses generated by a predetermined operation satisfies fixed rules.

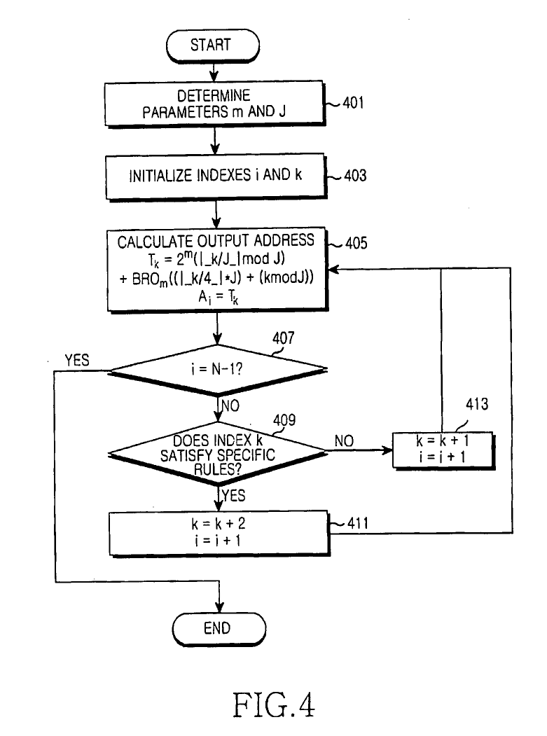

FIG. 4 is a flowchart of a method of generating a read address in an interleaver according to the present invention. Referring to FIG. 4, in step 401, the interleaver determines values of parameters m and J according to a size of an encoding packet. The values of the parameters m and J are obtained from a predetermined table such as Table 2 above. For example, if the size of the encoding packet is “2400”, the values of the parameters m and J are determined as “11” and “4”, respectively.

The interleaver proceeds to step 403 to initialize indexes i and k to “0”, wherein the indexes i and k are related to an index of a read address. In step 405, the interleaver performs an operation such as Equation (3) below using the index k to generate a read address Ai. The read address Ai is used to randomly read data which has been sequentially stored in an interleaver memory.
Tₖ=2^{m}(└k/J┘mod J)+BRO((└k/4┘*J+(k mod J)) (3)
wherein m and J denote the parameters determined according to the size of the encoding packet, BRO(H) denotes a function for bit reverse ordering of H, and mod and / denote a modulo operation and a divider operation for obtaining a remainder and a share, respectively.

In step 407, the interleaver detects whether the index i is equal to “(N−1)”. In other words, the interleaver detects whether all of read addresses have been generated. If the index i is smaller than “(N−1)”, the interleaver proceeds to step 409. If the index i is equal to “(N−1)”, the interleaver ends the present process.

In step 409, the interleaver determines whether the index k satisfies specific rules, e.g., Table 3. In other words, the interleaver determines whether a next index k is an index to be discarded. If the next index k does not satisfy the rules, i.e. index k is an effective index, the interleaver goes to step 413 to increase each of the indexes k and i by “1” and then returns to step 405 to generate a next read address.

If the next index k satisfies the rules, i.e. index k is the index to be discarded, the interleaver proceeds to step 411 to increase the index k by “2” so as to skip the next index k and increase the index i by “1” and then returns to step 405 to generate a next read address.

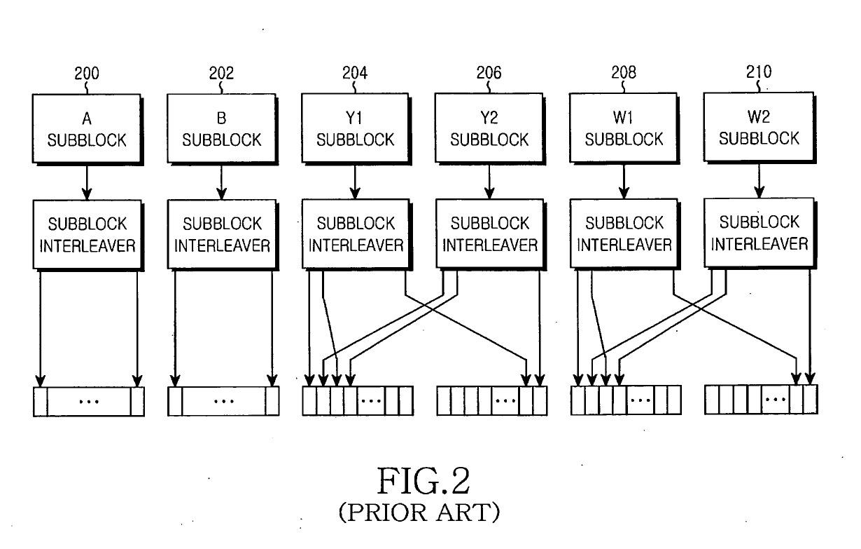

Accordingly, in the present invention, a read address to be discarded is recognized in advance in order to disallow the read address to be generated from the start. If sub-blocks are interleaved as described with reference to FIG. 2 and a data size of each of the sub-blocks is “2400”, an existing interleaving method requires 3072(2¹⁰×3) clocks to obtain 2400 effective read addresses. However, an interleaving method of the present invention can generate all of the effective read addresses using 2400 clocks. Also, if the sub-blocks are interleaved in parallel, the existing interleaving method requires 3076×6 clocks. However, the interleaving method of the present invention can reduce a number of clocks to 2400.

As described above, in an interleaving apparatus and method in a communication system according to the present invention, a value (an index k) corresponding to a corresponding address cannot be counted based on the fact that an address to be discarded among addresses generated for interleaving and/or deinterleaving operations satisfies rules. Thus, a number of clocks required for interleaving and/or deinterleaving can be reduced. In other words, a time required for interleaving and/or deinterleaving can be considerably reduced. Also, a read address can be generated at every predetermined cycle to reduce the complexity of hardware.

An interleaver has been exemplarily described in the embodiments of the present invention. However, the present invention may be applied to a deinterleaver which performs a reverse operation of the interleaver.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An interleaving apparatus comprising:
a determiner for determining whether a next index k to be generated is an index to be discarded, and if the next index k is the index to be discarded, generating a skip signal;
an index generator responding to a clock to increase the next index k by “1” and output the increased index k, and if the skip signal is detected, increasing the index k by “2” and outputting the increased index k; and
an address generator performing a predetermined operation using the index k generated by the index generator to generate an address required for interleaving.

2. The interleaving apparatus of claim 1, wherein the determiner determines the index to be discarded using a lookup table in which rules for indexes immediately before indexes to be discarded are written.

3. The interleaving apparatus of claim 1, wherein the predetermined operation is:
Tₖ=2^{m}(└k/J┘mod J)+BROₘ((└k/4┘*J+(k mod J))
wherein m and J (where J is a multiple of “2”) denote parameters determined according to a size of an encoding packet, BRO(H) denotes a function for bit reverse ordering of H(binary bit stream), and mod and / denote a modulo operation and a divider operation for obtaining a remainder and a share, respectively.

4. The interleaving apparatus of claim 1, wherein the address generator comprises:
a lookup table providing the parameters m and J (where J is a multiple of “2”) determined according to a size of an encoding packet; and
an operator performing an operation using values of the parameters m and J obtained from the lookup table and the index k generated by the index generator to generate the address required for interleaving, the operation being:
Tₖ=2^{m}(└k/J┘mod J)+BROₘ((└k/4┘*J+(k mod J))
wherein BRO(H) denotes a function for bit reverse ordering of H(binary bit stream), and mod and / denote a modulo operation and a divider operation for obtaining a remainder and a share, respectively.

5. The interleaving apparatus of claim 1, further comprising an interleaver memory which sequentially stores input data and interleaves and outputs the stored data according to the address generated by the address generator.

6. A transmitting apparatus in a communication system, comprising:
a channel coder encoding and outputting transmitted data; and
a channel interleaver interleaving and outputting the transmitted data encoded by the channel coder,
wherein the channel interleaver comprises:
a determiner for determining whether a next index k to be generated is an index to be discarded, and if the next index k is the index to be discarded, generating a skip signal;
an index generator responding to a clock to increase the next index k by “1” and output the increased index k, and if the skip signal is detected, increasing the index k by “2” and outputting the increased index k; and
an address generator performing a predetermined operation using the index k generated by the index generator to generate an address required for interleaving.

7. The transmitting apparatus of claim 6, wherein the channel coder is a convolutional turbo code (CTC) coder.

8. The transmitting apparatus of claim 6, wherein the channel interleaver separately interleaves a plurality of sub-blocks generated by the channel coder.

9. The transmitting apparatus of claim 6, wherein the determiner determines the index to be discarded using a lookup table in which rules for indexes immediately before indexes to be discarded are written.

10. The transmitting apparatus of claim 6, wherein the channel interleaver further includes an interleaver memory which sequentially stores input data and interleaves and outputs the stored data according to the address generated by the address generator.

11. The transmitting apparatus of claim 6, wherein the predetermined operation is:
Tₖ=2^{m}(└k/J┘mod J)+BROₘ((└k/4┘*J+(k mod J))
wherein m and J (where J is a multiple of “2”) denote parameters determined according to a size of an encoding packet, BRO(H) denotes a function for bit reverse ordering of H(binary bit stream), and mod and / denote a modulo operation and a divider operation for obtaining a remainder and a share, respectively.

12. The transmitting apparatus of claim 6, further comprising a puncturer which punctures the data output from the channel interleaver to generate a sub-packet to be transmitted.

13. An interleaving method comprising:
sequentially storing input data in a memory;
responding to a clock to increase an index k by “1”, and if a next index k to be generated is an index to be discarded, increasing the index k by “2”;
performing a predetermined operation using the index k to generate an address; and
reading data from the memory according to the address.

14. The interleaving method of claim 13, wherein the predetermined operation:
Tₖ=2^{m}(└k/J┘mod J)+BROₘ((└k/4┘*J+(k mod J))
wherein m and J (where J is a multiple of “2”) denote parameters determined according to a size of an encoding packet, BRO(H) denotes a function for bit reverse ordering of H(binary bit stream), and mod and / denote a modulo operation and a divider operation for obtaining a remainder and a share, respectively.

15. A transmitting method in a communication system, comprising:
channel-encoding transmitted data;
sequentially storing the encoded data in a memory;
responding to a clock to increase an index k by “1”, and if a next index k to be generated is an index to be discarded, increasing the index k by “2”;
performing a predetermined operation using the index k to generate an address; and
interleaving and outputting the stored data according to the generated address.

16. The transmitting method of claim 15, wherein the encoding of the transmitted data is performed using a convolutional turbo code (CTC).

17. The transmitting method of claim 15, further comprising puncturing the interleaved data to generate a sub-packet to be transmitted.

18. An interleaving apparatus comprising:
means for sequentially storing input data;
means for responding to a clock to increase an index k by “1”, and if a next index k to be generated is an index to be discarded, increasing the index k by “2”;
means for performing a predetermined operation using the index k to generate an address; and
means for reading data according to the address.

19. A transmitter in a communication system, comprising:
means for channel-encoding transmitted data;
means for sequentially storing the encoded data;
means for responding to a clock to increase an index k by “1”, and if a next index k to be generated is an index to be discarded, increasing the index k by “2”;
means for performing a predetermined operation using the index k to generate an address; and
means for interleaving and outputting the stored data according to the generated address.
